(19) United States
(12) Patent Application Publication
(10) Pub. No.: US 2006/0143577 A1
(43) Pub. Date: Jun. 29, 2006

(54) GRAPHICAL USER INTERFACE FOR MANIPULATING GRAPHIC IMAGES AND METHOD THEREOF

(76) Inventors: Kuan-Hong Hsieh, Shenzhen, Guangdong (CN); Zai-An Pan, Shenzhen, Guangdong (CN); Bing Li, Shenzhen, Guangdong (CN)

Correspondence Address: NORTH AMERICA INTELLECTUAL PROPERTY CORPORATION, P.O. BOX 506, MERRIFIELD, VA, 22116, US

(21) Appl. No.: 11/163,468

(22) Filed: Oct. 20, 2005

(30) Foreign Application Priority Data
Dec. 24, 2004 (TW) 093140433

(51) Int. Cl. G06F 17/00

(52) U.S. Cl. 715/815; 715/810; 715/825; 715/830

(57) ABSTRACT

A method for enabling the manipulation of a plurality of items in a graphic user interface (GUI) is provided. One embodiment of the method includes steps of: dividing the plurality of items to a plurality of groups, each group and item are represented by a graphic image; arranging the plurality of groups in the form of a rotatable ellipse, wherein the plurality of groups are each movable into and out of an active area in the rotatable ellipse as an active group, and items of the active group are arranged in the form of a rotatable cylinder, each being movable into and out of a selectable area in the rotatable cylinder as a desired item; increasing in size as a graphic image moves toward and into the active area or the selectable area, attaining its largest size in the active area or the selectable area. A related system is also provided.

### FIELD OF THE INVENTION

The present invention relates to a graphical user interface (GUI), and more particularly to a GUI for manipulating graphic images in an intuitive and convenient way.

### DESCRIPTION OF RELATED ART

Graphical user interfaces (GUIs) conventionally include a tree type GUI, a ring type GUI, a rotatable cylinder type GUI, a combined type GUI, and so on. The tree type GUI is not very intuitive. The tree type GUI may be difficult or cumbersome to use, particularly when the size of the corresponding display is limited, such as in portable electronic devices. In order to select a desired graphic image from a plurality of graphic images, the graphic images are often arranged in a ring type pattern or a rotatable cylinder type pattern.

For example, reference is made to U.S. Pat. No. 6,208,342, issued on Mar. 27, 2001, and entitled “Graphical User Interface for Enabling Selection of a Selectable Graphic Image.” The patent discloses a system for enabling manipulation of a plurality of graphic images on a display screen, to enable a user to focus on and select a desired graphic image from the plurality of graphic images. The system includes a display screen and means for presenting a plurality of graphic images in the form of a rotatable wheel on the display screen. Each graphic image is movable into and out of a position as the selectable graphic image, with the selectable graphic image being displayed differently from the other graphic images. The system also includes means for enabling each graphic image to increase in size as it moves toward and into the position as a selectable graphic image, and decrease in size as it moves out of and away from the position as a selectable graphic image. That is, the selectable graphic image is the most visible, while the other graphic images are visible to varying degrees according to their positions relative to the selectable position. The system also includes means for enabling selection of the selectable graphic image on a rotatable wheel. However, this type of GUI displays fewer graphic images in a given-sized display screen than other types of GUI displays. If a user wants to select a desired graphic image from a plurality of graphic images, he/she should rotate the plurality of graphic images one by one to search for the desired graphic image. This can take an unduly long time, with no means being available to intuitively determine the location of the desired graphic image.

Therefore, a heretofore unaddressed need exists in the industry to overcome the aforementioned deficiencies and inadequacies.

### SUMMARY OF INVENTION

The present invention provides a system and method for enabling manipulation of a plurality of items in a graphic user interface (GUI). The present invention also provides a concise and intuitional GUI for displaying items. Visibility of the interface is improved, and accordingly operability of the system for manipulation of the GUI is improved.

One embodiment of the method for enabling the manipulation of a plurality of items in a graphic user interface (GUI) exemplarily includes the steps of: dividing the plurality of items into a plurality of groups, wherein each group comprises one or more items, and wherein each group is represented by a graphic image; arranging the plurality of groups in the form of a rotatable generally encircling arrangement, wherein each of the groups is movable into and out of an active area in the rotatable ellipse, the group in the active area being defined as an active group, and wherein items of the active group are arranged in the form of a rotatable cylinder comprising the selectable area; and enabling each graphic image to change in size upon movement thereof in the GUI, whereby an image of a group increases in size as it moves toward and into the active area, attaining its largest size in the active area, and an image of each item in the active group increases in size as it moves toward and into the selectable area, attaining its largest size in the selectable area.

One embodiment of the system for enabling the manipulation of a plurality of items in a graphic user interface (GUI) exemplarily includes: a display screen; means for enabling movement any of the items into and out of a selectable area of the display screen; means for dividing the plurality of items into a plurality of groups, wherein each group comprises one or more items, and each group is represented by a graphic image; means for arranging the plurality of groups in the form of a rotatable generally encircling arrangement, wherein each of the groups is movable into and out of an active area in the arrangement, a group in the active area being defined as an active group, and wherein items of the active group are arranged in the form of a rotatable cylinder, each item being movable into and out of a selectable area on the rotatable cylinder as the desired item; and means for enabling each graphic image to change in size upon movement thereof in the GUI, whereby an image of each group increases in size as it moves toward and into the active area, attaining its largest size in the active area, and an image of each item in the active group increases in size as it moves toward and into the selectable area, attaining its largest size in the selectable area.

Other systems, methods, features, and advantages will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF DRAWINGS

FIG. 1 is a block diagram of a display device for enabling manipulation of an on screen display (OSD) menu in accordance with a preferred embodiment of the present invention.

FIG. 2 is a schematic diagram of an exemplary OSD menu viewable in accordance with a preferred embodiment of the present invention.

FIG. 3 is similar to FIG. 2, but showing the OSD menu after selection of a desired related item therein.

### DETAILED DESCRIPTION

A system and method for enabling manipulation of a plurality of items in a graphic user interface (GUI) is provided. The system and method can be used in devices such as a display device, a media player, or a mobile telephone. In the preferred embodiment, for simplicity, a display device is depicted. The display device can display a concise and intuitional on-screen display (OSD) menu. The following detailed description is provided with reference to the attached drawings.

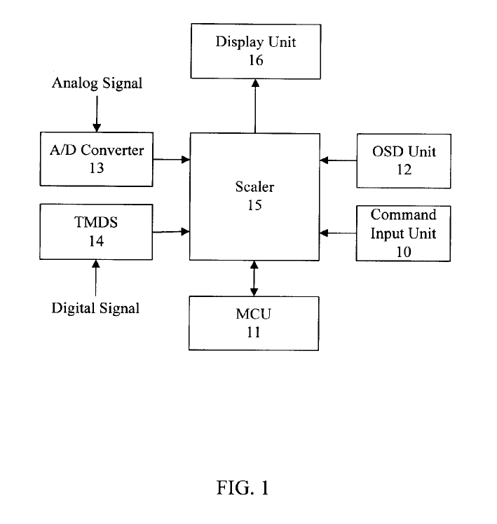

FIG. 1 is a block diagram of a display device for enabling manipulation of an on screen display (OSD) menu in accordance with a preferred embodiment of the present invention. The display device includes a command input unit 10, a micro-programmed control unit (MCU) 11, an on screen display (OSD) unit 12, an analog/digital converter (A/D converter) 13, a transition minimized differential signaling (TMDS) 14, a scaler 15, and a display unit 16.

The command input unit 10 generates control signals in response to an operation of a user. The operation can be turning on the display device, turning off the display device, displaying an OSD menu, adjusting any of various parameters of the display device, etc. The parameters of the display device mainly include volume level, color levels, brightness, contrast, vertical position, horizontal position, and so on. The OSD unit 12 stores a plurality of OSD data. When receiving a control signal to display the OSD menu, the scaler 15 obtains corresponding OSD data from the OSD unit 12 under the control of the MCU 11, and generates graphics signals for displaying the OSD menu.

The A/D converter 13 converts analog signals from a computer (not shown) into digital signals. Otherwise, the TMDS 14 directly transmits digital signals from the computer without conversion. The scaler 15 receives the digital signals, and transmits video signals to the display unit 16. Moreover the scaler 15 overlaps the digital signals and the OSD data from the OSD unit 12 to generate overlapped video signals. The display unit 16 can display either the video signals or the overlapped video signals. In the latter case, the display unit 16 displays an overlapped image, including a video image and an OSD menu, according to the overlapped video signals. This is done when the user initially operates the command input unit 10 to display the OSD menu. Subsequently, the scaler 15 can adjust any of the parameters of the display device under the control of the MCU 11, according to a corresponding control signal sent from the command input unit 10. The command input unit 10 may comprise buttons, knobs, touch pads, or any other suitable type of manipulable objects as user interfaces.

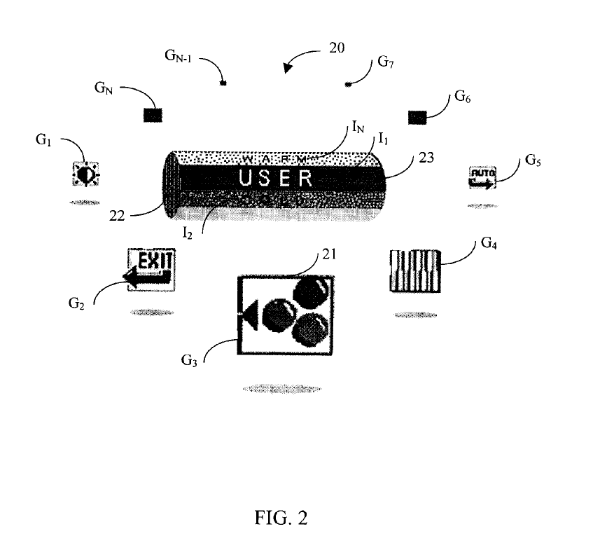

FIG. 2 is a schematic diagram of an exemplary on screen display (OSD) menu 20 viewable in accordance with a preferred embodiment of the present invention. The OSD menu 20 includes a plurality of function groups labeled from G₁ to G_{N}. Each function group has a set of related items, similarly labeled from I₁ to I_{N}. In the preferred embodiment of the present invention, the function groups and the related items are each symbolically represented by an icon. The icon is a bitmap and may be represented by a particular symbol such as a figure, characters, or a figure-character combination. Furthermore, the function group icons are arranged in the form of a rotatable ellipse, and each icon has a projection appearing as a shadow below itself. Each icon and its projection are together hereinafter simply referred to as an “icon.” Each icon is changeable in size upon movement thereof on the OSD menu 20 toward, into, and away from an active area 21. That is, each icon increases in size as it moves toward and into the active area 21, attaining its largest size in the active area 21. In contrast, each icon decreases in size as it moves out of and away from the active area 21, to be displayed in a faint mode or even be hidden altogether. In alternative embodiments, the function group icons may be distributed in the form of another kind of generally encircling arrangement, such as a rotatable ring.

When an icon moves into the active area 21, the function group represented by the icon becomes an active function group that can be further searched and manipulated by a user. The active function group can be displayed in a particular mode, such as a flashing mode, a pulsating size mode, or a steady mode, in order to further contrast the active function group with the other function groups displayed. Related items of the active function group on the active area 21 are arranged in the form of a rotatable cylinder 22. The rotatable cylinder 22 is shown in the center of the rotatable ellipse. In addition, the related items in the rotatable cylinder 22 can each be displayed in a different color. Furthermore, a related item in a selectable area 23 of the rotatable cylinder 22 can be displayed in a particular mode, such as a flashing mode, a pulsating size mode, or a steady mode, in order to contrast that related item with the other related items displayed. Like the function groups, each related item in the rotatable cylinder 22 is changeable in size upon movement thereof on the rotatable cylinder 22 toward, into, and away from the selectable area 23. Each item increases in size as it moves toward and into the selectable area 23, attaining its largest size in the selectable area 23. In contrast, each icon decreases in size as it moves out of and away from the selectable area 23, to eventually vanish.

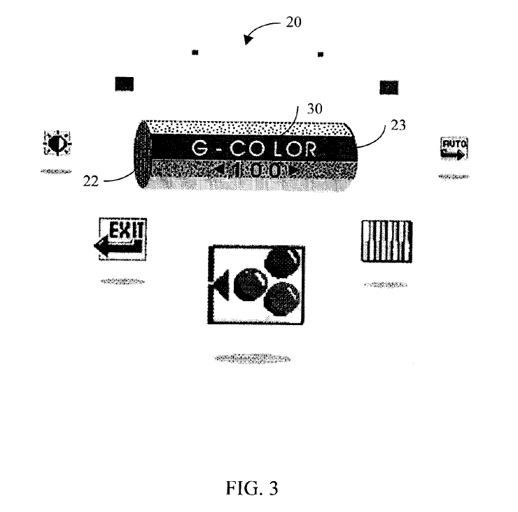

FIG. 3 is a schematic diagram of the OSD menu 20 viewed after selection of a desired related item in accordance with the preferred embodiment of the present invention. Once the desired related item in the selectable area 23 shown in FIG. 2 is selected, the OSD menu 20 as shown in FIG. 3 is displayed. In the illustrated embodiment, the desired related item is “G-Color.” A sub-item 30 of the desired related item is displayed in the selectable area 23. Furthermore, a value of the sub-item 30 is displayed adjacent the selectable area 23 of the rotatable cylinder 22, for example, below the selectable area 23. In the illustrated embodiment, the value is a measure of a current status of the “G-Color” item, and the value displayed is “100.” The value can be adjusted by the user operating the command input unit 10, and then the new value can be stored in the OSD unit 12.

It should be emphasized that the above-described embodiments, including any preferred embodiments, are merely possible examples of implementations, and are set forth for a clear understanding of the principles of the invention. Many variations and modifications may be made to the above-described embodiments without departing substantially from the spirit and principles of the invention. All such modifications and variations are intended to be included herein within the scope of this disclosure and the present invention, and be protected by the following claims.

What is claimed is:

1. A system for enabling the manipulation of a plurality of items in a graphic user interface (GUI), the system comprising:
a display screen;
means for enabling movement any of the items into and out of a selectable area of the display screen;
means for dividing the plurality of items into a plurality of groups, wherein each group comprises one or more items, and each group is represented by a graphic image;
means for arranging the plurality of groups in the form of a rotatable generally encircling arrangement, wherein each of the groups is movable into and out of an active area in the arrangement, a group in the active area being defined as an active group, and wherein items of the active group are arranged in the form of a rotatable cylinder, each item being movable into and out of a selectable area on the rotatable cylinder as the desired item; and
means for enabling each graphic image to change in size upon movement thereof in the GUI, whereby an image of each group increases in size as it moves toward and into the active area, attaining its largest size in the active area, and an image of each item in the active group increases in size as it moves toward and into the selectable area, attaining its largest size in the selectable area.

2. The system according to claim 1, further comprising means for adjusting a variable value associated with a desired item located in the selectable area.

3. The system according to claim 1, wherein the rotatable cylinder is in the center of the arrangement.

4. The system according to claim 1, wherein the images of the groups vary in size in the range from a pinpoint to the largest size.

5. The system according to claim 1, wherein the active group in the active area is displayed in a predetermined mode, for visually attracting the attention of a user.

6. The system according to claim 5, wherein the predetermined mode is a flashing mode, a pulsating size mode, or a steady mode.

7. The system according to claim 1, wherein the desired item in the selectable area is displayed in a predetermined mode, for visually attracting the attention of a user.

8. The system according to claim 7, wherein the predetermined mode is a flashing mode, a pulsating size mode, or a steady mode.

9. The system according to claim 1, wherein the arrangement is generally elliptical or circular.

10. A method for enabling manipulation of a plurality of items in a graphic user interface (GUI), and enabling the movement any of the items into and out of a selectable area, the item in the selectable area being defined as a desired item, wherein each item is represented by a graphic image, the method comprising steps of:
dividing the plurality of items into a plurality of groups, wherein each group comprises one or more items, and wherein each group is represented by a graphic image;
arranging the plurality of groups in the form of a rotatable generally encircling arrangement, wherein each of the groups is movable into and out of an active area in the rotatable ellipse, the group in the active area being defined as an active group, and wherein items of the active group are arranged in the form of a rotatable cylinder comprising the selectable area; and
enabling each graphic image to change in size upon movement thereof in the GUI, whereby an image of a group increases in size as it moves toward and into the active area, attaining its largest size in the active area, and an image of each item in the active group increases in size as it moves toward and into the selectable area, attaining its largest size in the selectable area.

11. The method according to claim 10, further comprising the step of adjusting a variable value associated with the desired item located in the selectable area.

12. The method according to claim 10, wherein the rotatable cylinder is in the center of the arrangement.

13. The method according to claim 10, wherein the images of the groups vary in size in the range from a pinpoint to the largest size.

14. The method according to claim 10, wherein the active group in the active area is displayed in a predetermined mode, for visually attracting the attention of a user.

15. The system according to claim 14, wherein the predetermined mode is a flashing mode, a pulsating size mode, or a steady mode.

16. The method according to claim 10, wherein the desired item in the selectable area is displayed in a predetermined mode, for visually attracting the attention of a user.

17. The system according to claim 16, wherein the predetermined mode is a flashing mode, a pulsating size mode, or a steady mode.

18. The system according to claim 10, wherein the arrangement is generally elliptical or circular.
